(19) United States
(12) Patent Application Publication
(10) Pub. No.: US 2026/0360031 A1
(43) Pub. Date: Nov. 12, 2026

(54) Method for obtaining a data grid containing data representative of a dynamically represented scene, and corresponding device and program

(71) Applicant: INSTITUT NATIONAL DE RECHERCHE EN INFORMATIQUE ET EN AUTOMATIQUE, LE CHESNAY (FR)

(72) Inventors: Lukas RUMMELHARD, Grenoble (FR); Jean-Alix DAVID, Meylan (FR); Amaury NEGRE, Villard-Bonnot (FR); Christian LAUGIER, Montbonnot Saint-Martin (FR)

(21) Appl. No.: 19/134,872

(22) PCT Filed: Nov. 10, 2023
(86) PCT No.: PCT/EP2023/081506

§ 371 Date: Jun. 2, 2025

(30) Foreign Application Priority Data
Dec. 9, 2022 (FR) FR2213122

(51) Int. Cl. G06T 11/60; G06T 7/246

(52) U.S. Cl. CPC G06T 11/60; G06T 7/246; G06T 2207/20076; G06T 2210/56

(57) ABSTRACT

A method for obtaining a state grid of data representative of a dynamically represented scene. The method includes: updating probability distributions of a static characterization grid characterizing the scene, as a function of at least one static state associated with at least one cell of the static grid, according to a static model; updating probability distributions of a dynamic characterization grid characterizing the scene, as a function of at least one particle associated with at least one cell of the dynamic grid, according to a dynamic model; fusing, in a resulting state grid, the probability distributions of the static and dynamic grids, which provides, for each cell, a state prediction and a velocity prediction; and evaluating, for at least one cell of the resulting state grid, probability of a final state and an associated velocity as a function of the predictions and any data received from a sensor.

### FIELD

The invention relates to the field of computer vision devices and autonomous machines in general that interact with their environment, such as a robot or an autonomous vehicle. For these machines, the ability to accurately perceive and model their environment in an appropriate form is an essential task. Whether for navigation, collision awareness, intention planning or mapping, this perception stage poses a challenge in terms of accuracy, complexity and uncertainty management.

More specifically, the invention relates to a generic dynamic state grid tracker and to a corresponding method, which filters the states of the cells and infers the dynamics of the scene captured by one or more sensors through the interaction of a static grid-based model and a dynamic particle-based model.

### PRIOR ART

Despite impressive developments and the development of ever-increasing onboard intelligence on mobile machines, the ability of an autonomous agent to perceive its environment accurately, robustly and efficiently remains a major challenge in robotics. The quality of the modelling of the environment depends not only on the sensors, but also on the interpretation schemata which process sensor errors, occlusions, contradictions in data, highly complex parameters, etc. Probabilistic methods have been developed to formally model uncertainties and prior knowledge in these interpretation schemata.

When these interpretation schemata are confronted with objects in motion, numerous additional problems arise. A classic approach to this problem is to adopt an object-based representation, which entails a tracking of multiple objects. Another common approach is the field of occupancy grids, which works with spatial occupancy without a higher-level segmentation. This approach has significant advantages, such as a spatially dense model with a correct representation of free space, which is an important datum in mobile robotics. Moreover, the critical steps of data segmentation and data recognition, which are necessary in object-based representations, can be avoided. When it is applied to dynamic environments, it is generally necessary to enrich this representation by estimating velocity information.

In the case of methods designed specifically for specific sensors, the velocity can be derived from the sensor measurements. In many cases, however, a more generic approach is necessary. The Bayesian Occupancy Filter (BOF) is a generic Bayesian framework that updates a dynamic occupancy grid by filtering the occupancy and the velocity in each cell in parallel. The observation model is incorporated in the form of an instantaneous occupancy grid generated by mapping the sensor data onto a grid by means of a probabilistic sensor model. A Bayesian filtering methodology based on a prediction-correction loop is used to filter the distributions in each cell, using neighbourhood transition histograms. This particular design for discretizing motion is practical for modelling the evolution of the cells but entails high calculation costs and aliasing problems.

To reduce the dimensions of the motion field, it is possible to use preexisting mapping data, or more generally a motion-distribution sampling method, wherein the histogram in each cell is mostly empty. Adaptive sampling methods can reduce the dimensions of motion representation considerably, as most cells, such as empty or static cells, do not require elaborate representations. In some processes, a variable number of samples per cell is used as a function of the estimated occupancy. The scene is represented by a set of (fictitious) particles in motion that have non-discretized positions and values, which corrects most aliasing problems.

Hybrid approaches exist. It is thus possible to implement interactions between grid-based and object-based representations. More recently, by using a different mathematical framework, an approach using random finite sets and filters on belief functions, a system designed to accurately resolve the problem of tracking multiple objects in occupancy grids was proposed.

The hybrid-sampling Bayesian occupancy filter, as disclosed in FR3022049A1, modifies the BOF structures and analyses the scene through a static-dynamic duality. The static part is an occupancy grid, and the dynamic field is conveyed by (fictitious) particles in motion in the occupancy grid. The two sections are generated and evaluated jointly, wherein their distributions over the cells are adjusted. This filter permits more efficient calculations, by concentrating the velocity calculations on the dynamic components, by offering a more compact model, and by bringing about a drastic improvement in the accuracy of the system. It has additionally been proposed, based on the approach disclosed in FR3022049A1, to introduce formal states into the filtering process which represent static occupancy, dynamic occupancy, empty and unknown areas. This formalism clarifies the overall presentation of the algorithm (for transitions, initialization, etc.), while the unknown state enables a specific processing and a focusing of the particles on the relevant dynamic areas. While the filtered low-level representation can be used directly, for mapping, the short-term risk evaluation, a rapid dynamic-occupancy clustering method, is directly integrated in the process, which enables a simplified analysis.

However, this development, just like the previous approach of FR3022049A1, has the disadvantage that it does not offer a retention of elements, particularly of dynamic elements, managed in the grid. More particularly, in a performed probabilistic calculation, as each antecedent contribution (the contribution from the occupancy grid and the contribution from the particles) is integrated independently, the “dynamic” occupancy predicted by particles is systematically reduced by the grid-based prediction of free or undefined space. In other words, the free space of the occupancy grid is systematically incorporated in the prediction, particularly in the prediction based on the particles, which reduces the weight of the “particle” prediction.

It would thus be necessary to provide a solution that makes it possible to resolve this problem.

### SUMMARY OF THE INVENTION

The invention was developed with these problems of the prior art in mind. More particularly, the invention relates to a method for obtaining a grid of data representative of a dynamically represented scene, referred to as a state grid, wherein said state grid is divided into cells, wherein the method is implemented by a computer module for processing data from at least one sensor.

According to the invention, this method includes at least one iteration of the following steps:
updating probability distributions of a static characterization grid that characterizes the scene, as a function of at least one static state associated with at least one cell of the static grid, according to a static model;
updating probability distributions of a dynamic characterization grid that characterizes the scene, as a function of at least one particle associated with at least one cell of the dynamic grid, according to a dynamic model;
fusing, in a resulting state grid, the probability distributions of the static grid and the dynamic grid, which provides, for each cell, a state prediction and a velocity prediction;
evaluating, for at least one cell of the resulting state grid, the probability of a final state and of an associated velocity as a function of the predictions and any data received from said at least one sensor.

According to a particular feature, the step of fusing the probability distributions includes, for a given cell of the resulting grid, a step of calculating the probability P(SpVp|SgpVgpSppVpp) wherein:
S^{p}: Predicted state of the cell at the current time step;
V^{p}: Predicted velocity of the cell at the current time step;

$${S}_{g}^{p} :$$

Predicted state of the cell at the current time step, predicted by the “static” model;

$${V}_{g}^{p} :$$

Predicted velocity of the cell at the current time step, predicted by the “static” model

$${S}_{p}^{p} :$$

Predicted state of the cell at the current time step, predicted by the “dynamic” model;

$${V}_{p}^{p} :$$

Predicted velocity of the cell at the current time step, predicted by the “dynamic” model.

According to a particular feature, the step of evaluating the probability of a final state and of an associated velocity includes, for a given cell of the resulting grid, a step of calculating the probability P(SV|SpVpSoVo), wherein:
S: State of the cell at the current time step;
V: Velocity of the cell at the current time step;
S^{p}: Predicted state of the cell at the current time step;
V^{p}: Predicted velocity of the cell at the current time step;
S^{o}: Observed state of the cell at the current time step;
V^{o}: Observed velocity of the cell at the current time step.

According to a particular feature, the update step includes:
a step of dynamically projecting particles, as a function of their velocities;
a step of applying a state modification to the static model;
a step of state transition, as a function of the model;
a shifting step, as a function of a shifting of the frame of reference.

According to a particular feature, after the evaluation step, it includes a step of resampling the particles in the dynamic model.

According to a particular feature, the particle resampling step includes:
a step of reallocating the particles as a function of the dynamic probability of each grid cell;
a particle generation step, as a function of previous assignments of the particles and the contribution of these previously assigned particles to the dynamic model.

According to a particular feature, the evaluation step uses an observation grid, wherein said observation grid includes data from said at least one sensor.

According to another aspect, the invention also relates to a module for obtaining a grid of data representative of a dynamically represented scene, referred to as a state grid, wherein said state grid is divided into cells, wherein the method is implemented by a computer module for processing data from at least one sensor. This module includes iterative calculation means for carrying out:
an update of probability distributions of a static characterization grid that characterizes the scene, as a function of at least one static state associated with at least one cell of the static grid, according to a static model;
an update of probability distributions of a dynamic characterization grid that characterizes the scene, as a function of at least one particle associated with at least one cell of the dynamic grid, according to a dynamic model;
a fusion, in a resulting state grid, of the probability distributions of the static grid and the dynamic grid, which provides, for each cell, a state prediction and a velocity prediction;
an evaluation, for at least one cell of the resulting state grid, of the probability of a final state and of an associated velocity as a function of the predictions and any data received from said at least one sensor.

According to a preferred implementation, the different steps of the methods according to the present disclosure are implemented by one or more software programs or computer programs, which include software instructions that are intended to be executed by a data processor of a device for processing occupation grids according to the present invention and that are designed to control the execution of the different steps of the methods, which are implemented at the level of a processing device, a remote server and/or a distributed system, within the framework of a distribution of the processing operations that are to be carried out and that are determined by a scripted source code or a compiled code.

Consequently, the present invention also concerns programs capable of being executed by a computer or by a data processor, wherein these programs include instructions for controlling the execution of the steps of methods such as those mentioned above.

A program can use any programming language, and be in the form of source code, object code, or intermediate code between source code and object code, such as in a partially compiled form, or in any other desirable form.

The present invention also concerns an information carrier that is readable by a data processor and that contains instructions of a program such as the one mentioned above.

The information carrier can be any entity or terminal capable of storing the program. For example, the carrier can include a storage medium, such as a ROM, for example a CD ROM or a microelectronic circuit ROM, or a magnetic recording medium, for example a mobile carrier (memory card) or a hard disk or an SSD.

Moreover, the information carrier can be a transmissible carrier such as an electrical or optical signal, which can be transmitted via an electrical or optical cable, by radio or by other means. In particular, the program according to the present invention can be downloaded from an Internet-type network.

Alternatively, the information carrier can be an integrated circuit in which the program is incorporated, wherein the circuit is adapted to execute or to be used in the execution of the method in question.

According to an example implementation, the present invention is implemented by means of software and/or hardware components. In this sense, the term “module” can correspond in this document just as well to a software component as to a hardware component or a combination of hardware and software components.

A software component corresponds to one or more computer programs, one or more subprograms of a program, or more generally to any element of a program or software program that can implement a function or set of functions, in accordance with what is described in the following for the concerned module. Such a software component is executed by a data processor of a physical entity (terminal, server, gateway, set-top-box, router, etc.) and is likely to have access to the hardware resources of this physical entity (memories, recording media, communication buses, electronic input/output cards, user interfaces, etc.). It is thus possible to decentralize the set of calculations, so that the calculations can be carried out in parallel, or even so that calculations and parameters can be exchanged between different devices (for example, different vehicles that perform calculations for one another).

Analogously, a hardware component corresponds to any element of a hardware set that can implement a function or a set of functions, in accordance with what is described in the following for the concerned module. This can be a programmable hardware component or a hardware component with an integrated processor for executing software, for example an integrated circuit, a chip card, a memory card, an electronic card for executing firmware, etc.

Each component of the system described in the foregoing naturally implements its own software modules.

The various embodiments mentioned above can be combined with one another for the implementation of the present invention.

### BRIEF DESCRIPTION OF THE FIGURES

Other objectives, features and advantages of the invention will become clearer from a reading of the following description—which is given as a simple illustrative, and not limitative, example—in relation to the figures, wherein:

FIG. 1 shows the Bayesian network representing the variable dependencies. The occupancy O can be deduced from the state S;

FIG. 2 shows the steps of the prediction model for the occupancy grid and the particles;

FIG. 3 outlines the steps implemented in the method according to the invention;

FIG. 4 shows a simplified physical architecture of an occupancy-grid processing device.

### DETAILED DESCRIPTION OF THE INVENTION

### 1. Review of Principles

As a reminder, an objective of the techniques known as “Bayesian Occupancy Filters”, to which the invention proposed here relates, is to estimate the spatial occupancy and its dynamics for an environment, which is observed using different types of sensors. To this end, the space is divided into spatial cells and random variables are associated with each cell. The probability distributions of these random variables are estimated recursively and used as a basis for interpreting the scene. The formal probabilistic model that is used, for example, in FR3022049A1, the formalism of which is incorporated, can be considered similar: despite the differences in the decomposition of the joint distribution and the parametric expressions, the main improvements did not lie in the equations of the model, but in the distinction static/dynamic, the differentiated representation, and the solving of equations. In later work, a change was introduced in the model and the calculations: instead of filtering occupancy directly, hidden states (s for “occupied by a static object”, d for “occupied by a dynamic object”, e for “empty” and u for “unknown”) (a variable with four possible states, but other states are also possible) representing what is present in a cell were added. The occupancy distribution of the cells could then be deduced from these hidden states. In addition to providing a clearer distinction between static and dynamic parts, the main point of this modification was to introduce a specific processing of areas without data, excluding them from the estimation of the velocity and deactivating their temporal persistence. As explained, however, this model is suboptimal in that it does not allow the evolution of the predictions from the dynamic model to be preserved over time, which results in a significant loss of information, particularly for the cells known as empty cells.

For this reason in particular, the inventors have determined a new model in which the predictions of the static and dynamic models are combined (upon completion) so as to preserve the occupancy dynamics of the cells over time and allow a better memorization of the dynamics of the cells.

In this model, as explained in the following, grid-based (static) predictions and particle-based (dynamic) predictions are kept separate and then combined in order to manage the different cases for the final prediction (associated with a cell). The ability to track a dynamic object over time is thus preserved, even when no new observation is available for that object. The grid on which the iterations are carried out and to which the application relates is a “semantic” occupancy grid, which includes states that are considered to be broader than a simple (binary) occupancy. It can also be called a state grid.

Thus, in this new model, and the implementation of the same, which is the subject of the present application, and in the version of the equations associated with the same, intermediate variables are added for the predicted states, the predicted velocity, the observed states, and the observed velocity. Specific variables are defined for the predicted states and velocities for each model (variables for a prediction based solely on grids, variables for a prediction based on the particle model), wherein the predicted state and velocity variables are, according to the invention, the result of the fusion of these two predictions, which are produced independently of each other. These two models are configured to represent the different parts of the captured scene and to optimize the allocation of particles only to the relevant areas, wherein their predictions are in turn fused with those relating to the (static) grid. The use of hidden variables in the filtering process makes it possible to manage, for example, contradictory state predictions or asynchronous sensors (for example, when the sensor sends data at frequencies that are lower than the frequency of the filtering module).

The formalism used in this description stems from the Bayesian programming framework. Given a set of random variables, the expression of their joint probability decomposition, the desired distribution can be expressed as presented in the following. Specific variables are defined for each model (variables for grid-based predictions, variables for particle-based predictions), wherein the predicted states and velocities are the result of the fusion of these fused predictions with the observed states. Only the occupancy data and the dynamics data of the states are explained in the following, but each state variable considered can include various semantic information about the cell (type of obstacle, type of navigable space, etc.).

### 1.1 Definition of Variables

In the context of the implementation of the present invention, the variables implemented in the model are as follows:
C: Index identifying each 2D cell;

$${C}_{g}^{- 1} :$$

Index that identifies each antecedent of a cell, used for the “static”, grid-based model

$${C}_{p}^{- 1} :$$

Index that identifies each antecedent of a cell, used for the “dynamic”, particle-based model;
S: State of the cell at the current time step. Possible states include, for example, “s” for “occupied by a static object”, “d” for “occupied by a dynamic object”, “e” for “empty” and “u” for “undefined”;
V: Velocity of the cell at the current time step, in R²;

$${S}_{g}^{- 1} :$$

State of the antecedent of the cell at the previous instant, according to the “static” (i.e. grid-based) model;

$${V}_{g}^{- 1} :$$

Velocity of the antecedent cell at the previous instant, according to the “static” model;

$${S}_{p}^{- 1} :$$

State of the antecedent of the cell at the previous instant, according to the “dynamic” (i.e. particle-based) model;

$${V}_{p}^{- 1} :$$

Velocity of the antecedent cell at the previous instant, according to the “dynamic” model;

$${S}_{g}^{p} :$$

Predicted state of the cell at the current time step, predicted by the “static” model. Possible states include, for example, “s” for “occupied by a static object”, “d” for “occupied by a dynamic object”, “e” for “empty” and “u” for “undefined”;

$${V}_{g}^{p} :$$

Predicted velocity of the cell at the current time step, predicted by the “static” model, in R²;

$${S}_{p}^{p} :$$

Predicted state of the cell at the current time step, predicted by the “dynamic” model. Possible states include, for example, “s” for “occupied by a static object”, “d” for “occupied by a dynamic object”, “e” for “empty” and “u” for “undefined”;

$${V}_{p}^{p} :$$

Predicted velocity of the cell at the current time step, predicted by the “dynamic” model, in R²;
S^{p}: Predicted state of the cell at the current time step. Possible states include, for example, “s” for “occupied by a static object”, “d” for “occupied by a dynamic object”, “e” for “empty” and “u” for “undefined”;
V^{p}: Predicted velocity of the cell at the current time step, in R²;
S^{o}: Observed state of the cell at the current time step. Possible states include, for example, “o” for “occupied”, “e” for “empty” and “u” for “undefined”;
V^{o}: Observed velocity of the cell at the current time step, in R²;
Z: Sensor measurement;
O: Occupation of the cell at the current time step. Its possible values are {occ,emp}. Not directly used in the inference, defined only later for applications and comparison with other methods.

The possible states are not limited to those set out here. It is possible to implement more precise and more numerous states such as, for example, “occupied by a cooperative pedestrian”, “occupied by an uncooperative pedestrian”, “aware of the presence of the automated entity (vehicle, robot)/not aware”, etc.

### 1.2 Joint Probability Distribution

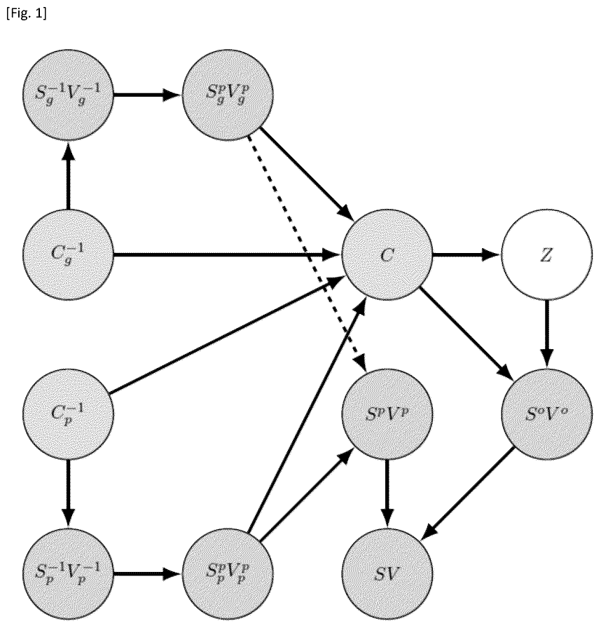

The Bayesian network illustrating the dependency of these variables is shown in FIG. 1. As can be seen, unlike in the prior art (notably HBOF), the dynamics (p) and the statics (g) of the scene are evaluated differently for a given cell C at a given iteration. To this end, the static evaluations and the dynamic evaluations take into account, separately, the anterior static evaluations and dynamic evaluations (from the previous iteration) before being combined and mixed with the probabilistic information from the one or more sensors.

Overall, the probability distribution is expressed by:

$$\begin{matrix}P ( C {C}_{g}^{- 1} {C}_{p}^{- 1} S V {S}_{g}^{- 1} {V}_{g}^{- 1} {S}_{p}^{- 1} {V}_{p}^{- 1} {S}_{g}^{p} {V}_{g}^{p} {S}_{p}^{p} {V}_{p}^{p} {S}^{o} {V}^{o} Z ) = \\ P ( {C}_{g}^{- 1} ) \cdot P ( {S}_{g}^{- 1} {V}_{g}^{- 1} \vert {C}_{g}^{- 1} ) \cdot P ( {S}_{g}^{p} {V}_{g}^{p} \vert {S}_{g}^{- 1} {V}_{g}^{- 1} ) \cdot P ( {C}_{p}^{- 1} ) \cdot \\ P ( {S}_{p}^{- 1} {V}_{p}^{- 1} \vert {C}_{p}^{- 1} ) \cdot P ( {S}_{p}^{p} {V}_{p}^{p} \vert {S}_{p}^{- 1} {V}_{p}^{- 1} ) \cdot P ( C \vert {C}_{g}^{- 1} {V}_{g}^{p} {C}_{p}^{- 1} {V}_{p}^{p} ) \cdot \\ P ( {S}^{p} {V}^{p} \vert {S}_{g}^{p} {V}_{g}^{p} {S}_{p}^{p} {V}_{p}^{p} ) . \\ P ( Z ) \cdot \\ P ( {S}^{o} {V}^{o} \vert ZC ) \cdot P ( SV \vert {S}^{o} {V}^{o} )\end{matrix} \qquad ( 1 )$$

Each expression can be interpreted as follows:
P(C_{g}⁻¹) is the distribution over all possible antecedents of the (grid, static) cell. It is chosen to be uniform because the cell is considered to be accessible from all possible antecedents with an equal probability;
P(S_{g}⁻¹V_{g}⁻¹|C_{g}⁻¹) is the conditional joint distribution over the state and the velocity of the antecedents. This distribution is updated at each time step (each iteration);
P(S_{g}^{p}V_{g}^{p}|S_{g}⁻¹V_{g}⁻¹) is the prediction model, according to the “static”, grid-based model; the states and the velocity are inextricably linked, because the definition of the state is directly linked to the velocity: the velocity in static parts is zero, while free and undefined parts have no associated velocity;
P(Cₚ⁻¹) is the distribution over all possible antecedents of the (particle, dynamic) cell. It is chosen to be uniform because the cell is considered to be accessible from all possible antecedents with an equal probability;
P(Sₚ⁻¹Vₚ⁻¹|Cₚ⁻¹) is the conditional joint distribution over the state and the velocity of the antecedents. This distribution is updated at each time step;
P(Sₚ^{p}Vₚ^{p}|Sₚ⁻¹Vₚ⁻¹) is the prediction model, according to the “dynamic”, particle-based model. The states and the velocity are inextricably linked, because the definition of the state is directly linked to the velocity: the velocity in static parts is zero, while free and undefined parts have no associated velocity;

$$P ( C \vert {C}_{g}^{- 1} {V}_{g}^{p} {C}_{p}^{- 1} {V}_{p}^{p} )$$

is the distribution that indicates whether the cell c is reachable from the antecedent [C_{g}⁻¹] with the velocity [V_{g}^{p}=v_{g}^{p}], and from the antecedent Cₚ⁻¹ with the velocity [Vₚ^{p}=vₚ^{p}]. This distribution is, for example, the product of two Dirac distributions with a value equal to 1 for one, only if

$${c}_{g}^{- 1} x + {v}_{g}^{p} δ t ∈ c and {c}_{d}^{- 1} x + {v}_{d}^{p} δ t ∈ c .$$

This allows the method to focus solely on the data projected by the two models of the cell c, and thus reduce the computational load;

$$P ( {S}^{p} {V}^{p} \vert {S}_{g}^{p} {V}_{g}^{p} {S}_{p}^{p} {V}_{p}^{p} )$$

is the prediction fusion model. The states and the velocity are inextricably linked, because the definition of the state is directly linked to the velocity: the velocity in static parts is zero, while free and undefined parts have no associated velocity;
P(Z) is the probability of a given observation Z. In this model, its value will not necessarily matter, as it will be the same factor for each potential S and V, Z being supplied.
P(S^{o}V^{o}|ZC) is the inverse distribution of the sensor model, the distribution that is calculated and given directly by the other modules;
P(SV|S^{p}V^{p}S^{o}V^{o}) is the probability of an SV (state/velocity) pair according to the predicted and observed states, which enables interactions between predictions and observations. A generation matrix or a more complex formula can be used.

### 1.3 Symbolic Expression of the Solved Problem

The aim of the Bayesian filtering process is to estimate the state and the velocity relative to the current observation for each cell: P(SV|ZC). In the system, filtering is applied to the hidden states; the state can then be deduced. Let O be the set of all variables:

$$𝒪 = \{ {CC}_{g}^{- 1} {C}_{p}^{- 1} {SVS}_{g}^{- 1} {V}_{g}^{- 1} {S}_{p}^{- 1} {V}_{p}^{- 1} {S}_{g}^{p} {V}_{g}^{p} {S}_{p}^{p} {V}_{p}^{p} {S}^{p} {V}^{p} {S}^{o} {V}^{o} Z \} \qquad ( 2 )$$

With a discretization of the antecedent cells and velocities, the filtering equation is written:

$$P ( SV \vert ZC ) = \frac{{\sum }_{𝒪 \backslash \{ CSVZ \}} P ( {CC}_{g}^{- 1} {C}_{p}^{- 1} {SVS}_{g}^{- 1} {V}_{g}^{- 1} {S}_{p}^{- 1} {V}_{p}^{- 1} {S}_{g}^{p} {V}_{g}^{p} {S}_{p}^{p} {V}_{p}^{p} {S}^{p} {V}^{p} {S}^{o} {V}^{o} Z )}{{\sum }_{𝒪} P ( {CC}_{g}^{- 1} {C}_{p}^{- 1} {SVS}_{g}^{- 1} {V}_{g}^{- 1} {S}_{p}^{- 1} {V}_{p}^{- 1} {S}_{g}^{p} {V}_{g}^{p} {S}_{p}^{p} {V}_{p}^{p} {S}^{p} {V}^{p} {S}^{o} {V}^{o} Z )} . \qquad ( 3 )$$

The distribution can then be expressed as:

$$\begin{matrix}P ( SV \vert ZC ) ∝ & {\sum }_{𝒪 \backslash \{ CSVZ \}} & P ( {C}_{g}^{- 1} ) \\ & & P ( {S}_{g}^{- 1} {V}_{g}^{- 1} \vert {C}_{g}^{- 1} ) \\ & & P ( {S}_{g}^{p} {V}_{g}^{p} \vert {S}_{g}^{- 1} {V}_{g}^{- 1} ) \\ & & P ( {C}_{p}^{- 1} ) \\ & & P ( {S}_{p}^{- 1} {V}_{p}^{- 1} \vert {C}_{p}^{- 1} ) \\ & & P ( {S}_{p}^{p} {V}_{p}^{p} \vert {S}_{p}^{- 1} {V}_{p}^{- 1} ) \\ & & P ( C \vert {C}_{g}^{- 1} {V}_{g}^{p} {C}_{p}^{- 1} {V}_{p}^{p} ) \\ & & P ( {S}^{p} {V}^{p} \vert {S}_{g}^{p} {V}_{g}^{p} {S}_{p}^{p} {V}_{p}^{p} ) \\ & & P ( Z ) \\ & & P ( {S}^{o} {V}^{o} \vert ZC ) \\ & & P ( SV \vert {S}^{p} {V}^{p} {S}^{o} {V}^{o} )\end{matrix} \qquad ( 4 )$$

The cell occupancy can then be deduced:

$$P ( OV \vert ZC ) = {\sum }_{S} P ( O \vert S ) P ( SV \vert ZC ) \qquad ( 5 )$$

### 2. Description of an Example Solution of the Model

On the basis of this model and its features, a solution method is implemented according to the present invention. This method mainly includes three steps (prediction, fusion-evaluation and particle resampling), which are explained in the following.

### 2.1 Implementation of the Model

As explained in the definitions of the variables, the system is made up of two interconnected models, a “static” (grid-based) model and a “dynamic” (particle-based) model. In addition to the semantic data, the potential states are, for example:
The state “occupied by a static object” (s), which refers to an immobile occupation, which strictly speaking includes static objects, but also background data (buildings, etc.).
The state “occupied by a dynamic object” (d), which refers to a dynamic occupation.
The state “empty” (e), which corresponds to free space.
The state “undefined” (u), which is a state used to signify a lack of information, also a lack of confidence in the credibility of the other states.

Other states can of course be defined (such as, for example, “occupied by a pedestrian”, “occupied by a vehicle”, “occupied by a cyclist”, etc.), in particular as a function of the data supplied by the sensors.

The static model includes a state grid (occupancy grid), wherein each cell encodes its state distribution. The elements that are estimated by the filter as static are represented in this cell grid. The dynamic model consists in a set of particles in motion, wherein each particle has a real position and velocity, as well as a “weight” corresponding to the probability that the cell to which it (this particle) is estimated to belong is occupied by a dynamic object with this state and these dynamics. As only the occupancy and dynamic parts of the states are explained in detail here, all particles have the same (dynamic) state, but more generally they can also have an associated semantic state (car, pedestrian, etc.). More specifically, at each iteration of the filter (at each time step, for example), the two models are used independently for the prediction, then fused and evaluated together, and finally segmented again. If the type of states taken into account can differ, some correspond to occupied cells (pedestrian, car, building, etc.) or empty cells (road, sidewalk, etc.), and each can have a specific motion model.

Thus, in the dynamic model, each particle has a real position and velocity, as well as a “weight”. This weight is representative of the probability that the cell (to which it is estimated the particle belongs) is occupied by a dynamic object with this state and these dynamics. The elements that are estimated by the filter as dynamic are represented in the dynamic model (objects in motion). The particles are distributed in a cell grid, the dimensions of which are identical to the grid of the static model. At each iteration, the two grids (the two models) are updated independently of each other and then fused to provide a “final” grid.

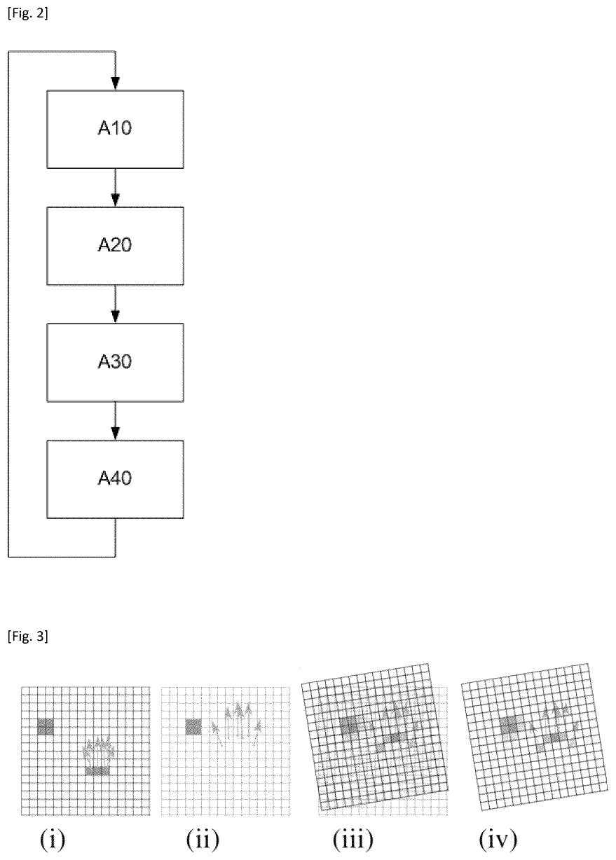

FIG. 2 shows the general method implemented in the device for processing the occupancy grids. Based on a current occupancy grid, the method includes:
a step of updating (A10) the static model, consisting in determining state and velocity predictions for at least one cell of the current occupancy grid as a function of the probabilities of the static model determined at the previous iteration, delivering predictions of the static model [at time step t+1];
a step of updating (A20) the dynamic model, consisting in determining state and velocity predictions for at least one fictitious particle of the current occupancy grid as a function of the probabilities of the dynamic model determined at the previous iteration, delivering predictions of the dynamic model [at time step t+1];
a step of fusing (A30) the predictions of the static model and the predictions of the dynamic model, according to a predetermined fusion pattern;
a step of evaluating (A40) the fused predictions as a function of optional observation data from at least one sensor, for example a probabilistic sensor.

An advantage of this solution is that it is possible to update the final predictions without data from sensors: the processing of the grids can be carried out independently of the receipt of the data from the sensor. For example, the module implementing the method of the invention can carry out “asynchronous” updates, which are performed at a frequency of 100 Hz; for their part, the sensors can transmit data at a frequency of 20 Hz and numerous iterations of the proposed method take place without an “observation” (a complete state grid with the state “unknown” is used instead of data from the one or more sensors); the filtered state is then based solely on the prediction made based on the previous states, by separating the particle prediction from the “grid” prediction, as explained in the foregoing.

### 2.2 Predictions

As indicated in the foregoing, the two models are projected separately, wherein the final prediction is the result of fusing these predictions. In other words, two predictions are carried out (update of the static model and update of the dynamic model), which are predicted separately and then fused. For each model, the update steps leading to the prediction include:
a dynamic projection: as a function of the time that has elapsed since the previous iteration, the particles are projected as a function of their velocities and the Gaussian position and velocity noise. The occupancy grids are defined here as static.
a state transition: each (static, dynamic) model is associated with transition matrices, which enable state transitions. In practice, these matrices mainly consist in a slow transition to the state “undefined”, which represents a loss of confidence in the estimated data over time. The occupied (static, dynamic) states are defined so as to be more consistent over time than the free states.
a shifting of the reference frame: as the system is intended to be installed on board vehicles in motion (which are thus mobile), the models must be shifted as a function of egomotion. The representation of the models simplifies what is quite a complex operation, the operation consisting in the transformation of the particle vectors (translation and rotation for positions, rotation for velocity) and the interpolation of the grids. Grid areas corresponding to newly discovered regions are initialized with the state undefined (u), while deleted areas can either be forgotten (in many mobile-robot applications, this data storage is irrelevant) or used to generate a map based on the static part.

FIG. 3 schematically illustrates the prediction process:
(i) Models at the previous time step. The two models (grids and particles) are shown superimposed.
(ii) Dynamic projection (for the grids and the particles, according to the motion models) and state transitions (according to the state transition models).
(iii) Expression of the data in the new reference frame, by interpolation of the grids and translation and rotation of the particles.
(iv) Models predicted at the current time step (the two grids are shown superimposed).

The potential values of these predictions are pre-calculated (and pre-sampled), so that the values:
P(C_{g}⁻¹)P(S_{g}⁻¹V_{g}⁻¹|C_{g}⁻¹)P(S_{g}^{p}V_{g}^{p}|S_{g}⁻¹V_{g}⁻¹) and P(Cₚ⁻¹)P(Sₚ⁻¹Vₚ⁻¹|Cₚ⁻¹)P(Sₚ^{p}Vₚ^{p}|Sₚ⁻¹Vₚ⁻¹)
   are calculated independently (and these values are directly associated with the relevant grid cells and particles).

### 2.3 Fusion of the Predictions and Evaluations

The updated distributions over the states are evaluated in parallel in each cell of the current grid. All predicted particles are reorganized as a function of their position in the grid, so that only particles and data of relevant cells are transmitted for the calculation regarding the current grid cell (according to P(C|C_{g}⁻¹V_{g}^{p}Cₚ⁻¹Vₚ^{p})). In other words, only cells for which P(C|C_{g}⁻¹V_{g}^{p}Cₚ⁻¹Vₚ^{p}) exceeds a certain threshold are transmitted for fusion and evaluation.

a. Fusion of the predictions: according to the fusion model defined by P(S^{p}V^{p}|S_{g}^{p}V_{g}^{p}Sₚ^{p}Vₚ^{p}), each static and dynamic prediction sample generates final predictions. The fusion model can be devised with precision (and could even be learned), but the main object is to define it in such a manner that, if a model predicts a dynamic state, the fusion results in a dynamic state. Or, if a model predicts a static state, the fusion results in a static state. Or, if a model predicts a free state, the fusion results in a free state. And an undefined state (u) is only generated if both (static and dynamic) models each predict an undefined state. This way, for example, the prediction of a moving object arriving in previously free (f) or undefined (u) cells is not weakened, which guarantees the durability of the information (over time) and thus allows the encountered problems to be solved.

b. Evaluation: in a given cell “c”, these final predictions are compared with the observation P(S° V° IZC). The observation model used is based on a classic probabilistic sensor model, which takes into account the relevance of the data of the sensor (confidence of the sensor, localization of impacts, height of impacts, vertical distribution, etc.). The observation model can be defined for any type of sensor, and the distributions can be fused by means of probability fusion rules, which enables an integration of heterogeneous data and a generic processing. The state definition used in this model can also be different from the filtered definition.

For example, the observation model can be based on a classic probabilistic sensor model, with the addition of the evaluation of the indefinite state (u), which correlates with the relevance of the data of the sensor. For example, in the case of laser data, the undefined model obtains low values before and around impact and obtains high values further on (when no information is available). To generate the estimation of the final state, the generative distribution P(SV|S^{p}V^{p}S^{o}V^{o}) is used, which defines the probability of a final state and the velocity as a function of the predictions and observations. This is given in the form of a generative matrix for the states (the parameters of which can or must be learned, as a function of the operational conditions of implementation), which enables, for example, the rapid appearance of objects in cells previously seen as free, while ensuring a slow disappearance of objects in cells now seen as free or undefined, or the absence of an impact of an undefined observation on the estimation of the final state (outside the scope of the natural erosion of predictions over time).

Once the predictions and the evaluations in view of the data supplied by the sensors have been fused, for this time step, a current grid is provided in which, for each (relevant) cell, the probability of a final state and velocity as a function of the predictions and the observations is obtained.

### 2.4 Resampling the Particles

Once the state distributions over the cells have been correctly estimated (calculated), the following task consists, in one example implementation, in a resampling of the particles, which includes, for example, the following two steps:

a. Reallocation of the particles: as a function of the dynamic probability of each grid cell, and of other criteria (position, difference between predicted and observed states, distribution of the velocities, etc.), the total number of particles is reallocated to the relevant cells.

b. Generation of particles: during the evaluation of the state distributions, the weight of each existing particle is updated and normalized, as a function of its relative contribution in the dynamic part. In each cell with which particles have been associated, the particles are then drawn from the existing particle distribution, and from an initialization distribution, according to the proportion of “dynamic appearance” (difference between predicted and observed states, velocity distribution, etc.). Finally, the cellular dynamic coefficient (i.e. the dynamic coefficient of the cell) is uniformly distributed between the particles (of this cell).

Unique markers are associated with each particle drawn from the initialization distribution, and propagated to particles extracted from already existing distributions, which enables a rapid and ultralight pre-segmentation of objects (or at least a coherent cluster in the occupancy spaces and the dynamic spaces). This resampling can be carried out by other means. It does not have to be limited to this approach.

### 3. Other Features, Improvements and Advantages

According to the invention, it is thus possible to greatly improve the quality of the predictions produced by previous systems, by ensuring that the predictions last longer in time. In addition, the invention also has the following advantages:
Specifiable sensitivity of the filters: a first major difference between the present invention and the filters cited in the foregoing is the introduction of intermediate state variables (S° V°) for evaluating the states of the model, instead of a direct evaluation based on the data. These “observed states” can have a different number of dimensions than the estimated state, and the relationship between each observed and estimated potential state can be designed, which explicitly defines the filtering sensitivity on a specific data input without affecting the temporal consistency of the filtered states. The separation of these two components of the filter resolves a practical problem of the previous approaches, in which the state appearance and disappearance rates were directly related.
independent update frequency: as already mentioned, this frequency also makes it possible, in conjunction with the use in the observation states of a specific representation for a “lack of data”, to uncouple the update frequencies of the filter from the update frequency of the sensors. And in correlation with the implementation of the GPU, it makes it possible to achieve update frequencies that are higher than the frequencies of the sensors, which enables a dynamic estimation of the scene even when no sensor data is received.
Adaptable prediction template: another major difference is the use of two distinct models for the prediction, a grid-based prediction (S_{g}^{p}V_{g}^{p}) and a particle-based prediction (Sₚ^{p}Vₚ^{p}), both of which are propagated independently at each iteration but fused (S^{p}V^{p}) and regenerated based on the state estimate. This strict separation (compared with the conditional sampling to date) and the configurable fusion solve another important problem of the previous method, in which it was not possible to adapt the persistence of a state in a cell as a function of other predictions. A typical case of such a problem is that, when a dynamic sample moves over free areas, without a new observation, the persistence of previously observed free cells reduces the probability of occupancy of the object in motion, until it disappears, even without a defined temporal state transition (dynamic transition model). Thanks to the method of the invention, when a cell predicts a “free” cell based on the first model, and a “dynamic” cell based on the second model (based on the particle projection), the predicted state is correctly defined as “dynamic”.

Thus, thanks to the implementation of the proposed method, it is possible to obtain a filter update frequency of 100 Hz, which is higher than the sensor frequencies. This higher update frequency renders possible a smoother filtering, a more precise integration of the data, and a well-defined reduction in temporal confidence, while simultaneously improving the operational reliability of the method (clear continuation of the propagation of the models in the event of sensor failure). The distinction between two models and the combined prediction ultimately resolve important problems, such as the undesirable rapid dilution of dynamic occupancy in areas formerly considered free or undefined. The addition of observation states results in a greater reactivity in the detection of particular states. Although the results are convincing, further research could focus on the quantitative validation of the approach, which remains a major challenge in the field of dynamic occupancy grid filtering, which lacks clear shared evaluation criteria, metrics and a reference database.

### 4. Processing Device

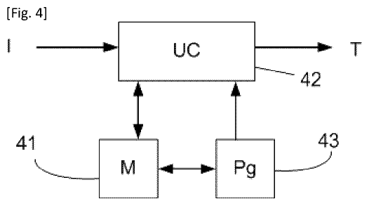

FIG. 4 shows a simplified architecture of a processing device for processing occupancy grids, which implements all or part of the method as presented in the foregoing. Such an occupancy-grid processing device includes a memory 41 and a processing unit 42 that is equipped, for example, with a microprocessor and that is controlled by the computer program 43, which implements the method according to the invention. In at least one example implementation, the invention is implemented in the form of an application installed on a device installed in a vehicle or in a (robotic) autonomous agent. Such an occupancy-grid processing device includes, for example, all or a portion of the following means:
update means for updating probability distributions of a static scene-characterization grid, as a function of at least one static state associated with at least one cell of the static grid, according to a static model;
update means for updating probability distributions of a dynamic scene-characterization grid, as a function of at least one particle associated with at least one cell of the dynamic grid, according to a dynamic model;
fusion means for fusing, in a resulting occupancy grid, the probability distributions of the static grid and the dynamic grid, which provides, for each cell, a state prediction and a velocity prediction;
evaluation means, for at least one cell in the resulting occupancy grid, for evaluating the probability of a final state and an associated velocity as a function of the predictions and observations.

These means can take the form of a specific software application, or the form of dedicated hardware components designed to carry out these functions, such as an ASIC.

1. A method implemented by a data processing device and comprising:
obtaining a grid of data representative of a dynamically represented scene, referred to as a state grid, said state grid being divided into cells, using a computer module for processing data from at least one sensor, wherein the obtaining includes at least one iteration of:
updating probability distributions of a static characterization grid that characterizes the scene, as a function of at least one static state associated with at least one cell of the static grid, according to a static model;
updating probability distributions of a dynamic characterization grid that characterizes the scene, as a function of at least one particle associated with at least one cell of the dynamic grid, according to a dynamic model;
fusing, in a resulting state grid, the probability distributions of the static grid and the dynamic grid, providing a state prediction and a velocity prediction for each cell; and
evaluating, for at least one cell of the resulting state grid, a probability of a final state and of an associated velocity as a function of the predictions and any data received from said at least one sensor.

2. The method according to claim 1, wherein the fusing the probability distributions includes, for a given cell of the resulting grid, calculating the probability P(S^{p}V^{p}|S_{g}^{p}V_{g}^{p}Sₚ^{p}Vₚ^{p}), wherein:
S^{p}: Predicted state of the cell at the current time step;
V^{p}: Predicted velocity of the cell at the current time step;
$${S}_{g}^{p} :$$
Predicted state of the cell at the current time step, predicted by the “static” model;
$${V}_{g}^{p} :$$
Predicted velocity of the cell at the current time step, predicted by the “static” model;
$${S}_{p}^{p} :$$
Predicted state of the cell at the current time step, predicted by the “dynamic” model;
$${V}_{p}^{p} :$$
Predicted velocity of the cell at the current time step, predicted by the “dynamic” model.

3. The method according to claim 1, wherein the evaluating the probability of a final state and of an associated velocity includes, for a given cell of the resulting grid, a step of calculating the probability P(SV|S^{p}V^{p}S^{o}V^{o}), wherein:
S: State of the cell at the current time step;
V: Velocity of the cell at the current time step;
S^{p}: Predicted state of the cell at the current time step;
V^{p}: Predicted velocity of the cell at the current time step;
S^{o}: Observed state of the cell at the current time step;
V^{o}: Observed velocity of the cell at the current time step.

4. The method according to claim 1, wherein the updating the probability distributions of the static characterization grid and the dynamic characterization grid includes:
dynamically projecting particles, as a function of their velocities;
applying a state modification to the static model;
state transition, as a function of the model;
shifting, as a function of a shifting of the frame of reference.

5. The method according to claim 1, wherein the method includes, after the evaluating, resampling the particles in the dynamic model.

6. The method according to claim 5, wherein the resampling the particles includes:
reallocating the particles as a function of the dynamic probability of each grid cell;
particle generation, as a function of previous assignments of the particles and the contribution of these previously assigned particles to the dynamic model.

7. The method according to claim 1, wherein the evaluating implements an observation grid, wherein said observation grid includes data from said at least one sensor.

8. A data processing device comprising:
at least one processor; and
at least one non-transitory computer readable medium comprising instructions stored thereon which when executed by the at least one processor configure the data processing device to obtain a grid of data representative of a dynamically represented scene, referred to as a state grid, said state grid being divided into cells, using a computer module for processing data from at least one sensor, wherein the obtaining comprises at least one iteration of:
an update of probability distributions of a static characterization grid that characterizes the scene, as a function of at least one static state associated with at least one cell of the static grid, according to a static model;
an update of probability distributions of a dynamic characterization grid that characterizes the scene, as a function of at least one particle associated with at least one cell of the dynamic grid, according to a dynamic model;
a fusion, in a resulting state grid, of the probability distributions of the static grid and the dynamic grid, providing a state prediction and a velocity prediction for each cell; and
an evaluation, for at least one cell of the resulting state grid, of a probability of a final state and of an associated velocity as a function of the predictions and any data received from said at least one sensor.

9. A non-transitory computer readable medium comprising a computer stored thereon program including program code instructions for executing a method when said program is executed on a processor, the method comprising:
obtaining a grid of data representative of a dynamically represented scene, referred to as a state grid, said state grid being divided into cells, using a computer module for processing data from at least one sensor, wherein the obtaining includes at least one iteration of:
updating probability distributions of a static characterization grid that characterizes the scene, as a function of at least one static state associated with at least one cell of the static grid, according to a static model;
updating probability distributions of a dynamic characterization grid that characterizes the scene, as a function of at least one particle associated with at least one cell of the dynamic grid, according to a dynamic model;
fusing, in a resulting state grid, the probability distributions of the static grid and the dynamic grid, providing a state prediction and a velocity prediction for each cell; and
evaluating, for at least one cell of the resulting state grid, a probability of a final state and of an associated velocity as a function of the predictions and any data received from said at least one sensor.
